(19) United States
(12) Patent Application Publication
(10) Pub. No.: US 2008/0212505 A1
(43) Pub. Date: Sep. 4, 2008

(54) METHOD AND RECEIVING APPARATUS FOR PROCESSING ARQ BLOCK IN WIBRO SYSTEM

(75) Inventors: Hyeun-Mok Jung, Suwon-si (KR); Seong-Woo Ahn, Yongin-si (KR); Seong-Hoon Jeong, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/969,039

(22) Filed: Jan. 3, 2008

(30) Foreign Application Priority Data
Jan. 3, 2007 (KR) 2007-538

(51) Int. Cl. H04B 7/00

(52) U.S. Cl. 370/310

(57) ABSTRACT

Disclosed is a receiving apparatus of a Wireless Broadband (WiBro) system and a method for processing an Automatic Repeat reQuest (ARQ) block for the same. In the receiving apparatus, ARQ blocks are grouped and are then processed by the group, thereby greatly reducing memory resources and overhead processing time, which is required in a case where the respective ARQ blocks are processed separately. Also, the generation of unnecessary purge timers in a receive (Rx) window of the receiving apparatus is reduced, thereby enabling the reduction of costs according to the operation of purge timers.

### PRIORITY

This application claims priority under 35 U.S.C. §119(a) to an application entitled “Method and Receiving Apparatus for Processing ARQ Block in WiBro System” filed in the Korean Industrial Property Office on Jan. 3, 2007 and assigned Serial No. 2007-538, the contents of which are incorporated herein by reference.

### BACKGROUND OF THE INVENTION

1. Field of the Invention

The present invention relates to a Wireless Broadband (WiBro) system, and more particularly to a receiving apparatus of a WiBro system and a method for processing an Automatic Repeat reQuest (ARQ) block for the same.

2. Description of the Related Art

A receiving apparatus of a WiBro system must be informed of an arrival of data to be processed. The receiving apparatus having been informed of the arrival of the data to be processed extracts an ARQ block from a Protocol Data Unit (PDU) existing within a frame. According to a mobile internet standard 802.16, developed by the Institute of Electrical and Electronic Engineers (IEEE), multiple PDUs can be included in one frame, and multiple ARQ blocks can be included in one PDU.

FIG. 1 illustrates a protocol layer of the mobile internet standard 802.16.

As illustrated in FIG. 1, the range of the mobile internet standard 802.16 covers a PHYsical (PHY) layer and a Media Access Control (MAC) layer. An ARQ used for the wireless mobile internet is included in an MAC Common Part Sublayer (CPS) within the MAC layer.

The ARQ is implemented in the MAC layer. Parameters, including the size of an ARQ receive (Rx) window, the size of an ARQ block, a related timer value, etc., are determined during the process of connection setting and negotiation through a Dynamic Service Addition (DSA) message and a Dynamic Service Change (DSC) message corresponding to MAC management messages defined in the Mobile Internet standard 802.16.

Parameters used for the operation of the ARQ Rx window of the receiving apparatus are as follows:
ARQ_RX_WINDOW_START: indicating that ARQ blocks having all Block Sequence Numbers (BSNs) up to ‘ARQ_RX_WINDOW_START−1’ are received by the receiving apparatus;
ARQ_RX_HIGHEST_BSN: representing the largest ‘BSN+1’ of received ARQ;
ARQ_RX_HIGHEST_BSN: the values ranging from ‘ARQ_RX_WINDOW_START’ to ‘ARQ_RX_WINDOW_START+ARQ_WINDOW_SIZE’; and
ARQ_WINDOW_SIZE: the maximum number of ARQ blocks having continuous BSNs which can exist in the ARQ Rx window.

If the ARQ Rx window of the receiving apparatus does not slide, even after the passing of a prescribed time, an ARQ purge timer managed by the receiving apparatus forces the ARQ Rx window to slide, thereby assisting the receiving apparatus in such a manner that the receiving apparatus can continue to maintain an operation thereof. When ARQ blocks are generated by a transmitting apparatus, each ARQ block is granted a Block Sequence Number (BSN). In the receiving apparatus, the Rx window can sense, from the value of ARQ_RX_WINDOW_START, an ARQ BSN which must be received. The Rx window slides when an ARQ block having a BSN equivalent to the ARQ_RX_WINDOW_START value is received. The Rx window of the receiving apparatus operates in such a manner that an ARQ_RX_WINDOW_START variable may incessantly indicate an ARQ block having the smallest BSN among ARQ blocks which are not yet received or ARQ blocks which are received along with errors. Also, if an ARQ block having a BSN indicated by an ARQ_RX_WINDOW_START is received, the Rx window of the receiving apparatus operates in such a manner that the ARQ_RX_WINDOW_START parameter may indicate an ARQ block having a BSN placing in the second ranking according to the increasing order of BSNs.

Since the Rx window of the receiving apparatus does not slide if the ARQ block having the BSN equivalent to the ARQ_RX_WINDOW_START value is not received, the purge timer begins to operate in regard to the relevant ARQ block. If the value of the purge timer for any ARQ block exceeds the ARQ_RX_PURGE_TIMEOUT value, a timeout condition is reflected in the relevant ARQ block, and at this time, the ARQ_RX_WINDOW_START proceeds to an ARQ block having the smallest BSN among ARQ blocks which are not yet received or ARQ blocks which have been received along with errors after the ARQ block in which the timeout condition is reflected.

According to the IEEE P802.16-2004/Cor1/D5 standard, which corresponds to a standard of the WiBro system, if an ARQ block which cannot slide the Rx window of the receiving apparatus is received, purge timers are arranged in all relevant ARQ blocks without any conditions, and then operate. In addition, each of the purge timers for the ARQ blocks existing in the Rx window remains in an active state until each BSN value is placed out of the Rx window, and then continues to be monitored on whether or not a timeout is reflected in each ARQ block.

The operation of a timer in the receiving apparatus will be described in detail.

FIGS. 2 and 3 illustrate an operation of the prior purge timer.

In FIG. 2, squares represent respective ARQ blocks received by the receiving apparatus, and numerals inside of the squares designate respective BSNs of the ARQ blocks. FIG. 2 depicts a case where ARQ blocks respectively having BSNs #0 to #7 are received normally, and then slide. As a result of sliding of the Rx window, the ARQ blocks respectively having the BSNs #0 to #7 are placed out of the Rx window, and then an ARQ_RX_WINDOW_START comes to indicate the position of an ARQ block having a BSN #8. If the ARQ block #8 is received normally after the ARQ block having the BSN #7 is received, the ARQ_RX_WINDOW_START comes to indicate #9. Nevertheless, in FIG. 2, in a state where ARQ blocks corresponding to BSNs #8 to #10 are not received after the ARQ block having the BSN #7 is received, ARQ blocks corresponding to BSNs #11 to #23 are received. Since all of the ARQ blocks corresponding to the BSNs #11 to #23 are not blocks which are not indicated by the ARQ_RX_WINDOW_START, with respect to each of the ARQ blocks corresponding to the BSNs #11 to #23, a purge timer comes to operate. The ARQ blocks corresponding to the BSNs #11 to #23 become targets subject to monitoring if the ARQ_RX_PURGE_TIMEOUT value is exceeded. The monitoring continues until the ARQ PURGE_TIMEOUT value is exceeded, or until a relevant ARQ block enters the Rx window. In FIG. 2, if the ARQ blocks corresponding to the BSNs #11 to #23 are received by the receiving apparatus during the same frame, each of the ARQ blocks comes to have the same purge timer value.

The purpose of the purge timers is that, as described above, following an ARQ block having an operating purge timer, the ARQ_RX_WINDOW_START is moved to an ARQ block having the smallest BSN among ARQ blocks which are not received or ARQ blocks which are received along with errors, thereby sliding the Rx window.

If the results of an operation of a purge timer corresponding to a target and the fact that multiple ARQ blocks are received during one frame are taken into account, it is meaningless to enable multiple purge timers all having the same value to operate within the Rx window of the receiving apparatus. However, in the current WiBro system, multiple ARQ blocks all having the same purge timer value are generated, which in turn generates unnecessary purge timers, the operation of purge timers is therefore not efficient.

In the case illustrated in FIG. 2, not only the ARQ block corresponding to the BSN #11, but also the ARQ blocks corresponding to the BSNs #12 to #23 have purge timers. As a result, purge timers of the ARQ blocks corresponding to the BSNs #12 to #23 and a purge timer possessed by the ARQ block corresponding to the BSN #11 duplicate one another. In conditions where the duplicate purge timers operate, if the purge timer possessed by the ARQ block corresponding to the BSN #11 reaches a timeout, so that the ARQ_RX_WINDOW_START may indicate a position of an ARQ block corresponding to the BSN #24 as illustrated in FIG. 3, the Rx window slides. Hence, the purge timers of the ARQ blocks corresponding to the BSNs #12 to #23, which are to be monitored, are initialized and become inactive. This means that until, with the generation of a purge timer with respect to each of the ARQ blocks corresponding to the BSNs #12 to #23, a value of the purge timer of the ARQ block corresponding to the BSN #11 exceeds the ARQ_RX_PURGE_TIMEOUT value, an operation for monitoring the purge timers of the ARQ blocks corresponding to the BSNs #12 to #23 every monitoring period that the purge timers are monitored becomes meaningless.

Since an ARQ_WINDOW_SIZE is set to a value less than 2¹¹/2 in a current mobile internet standard, about (2¹¹/2−2) number of purge timers can be operated in a duplicate manner in the worst case. This is accompanied by unnecessary tasks, including a first task where values of a (2¹¹/2−2) number of purge timers must be updated by each monitoring period, a second task where each of the updated values must be compared with the ARQ_RX_PURGE_TIMEOUT value, a third task where the Rx window has to be updated, and other tasks.

Also, together with the above-described operation problems regarding the purge timers, as a processing unit is set as an ARQ block in the ARQ block receiving apparatus, overhead can increase as well.

According to the mobile internet standard, in a connection in which an ARQ is used, aside from a SDU fragment corresponding to a basic transmission unit of a Service Data Unit (SDU), ARQ processing is performed in an ARQ block unit corresponding to a unit less than the SDU fragment. This is intended to raise retransmission efficiency by enabling a transmitting apparatus to retransmit only ARQ blocks required for retransmission. However, in the receiving apparatus, necessary memory and time increase due to overhead occurring in a case where data is processed in an ARQ block unit.

Therefore, there is a need for a scheme of an efficient ARQ block processing and an efficient operation of purge timers, which can minimize the above-stated problems.

### SUMMARY OF THE INVENTION

Accordingly, the present invention has been made to solve at least the above-stated problems occurring in the prior art, and the present invention provides a method which, in an ARQ block receiving apparatus of a Wireless Broadband (WiBro) system, reduces overhead caused when processing an Automatic Repeat reQuest (ARQ) block and the generation of unnecessary ARQ block purge timers in a receive (Rx) window, and a receiving apparatus for the same.

In accordance with an aspect of the present invention, there is provided a method for processing an ARQ block by a receiving apparatus of a WiBro system that includes grouping ARQ blocks having continuous Block Sequence Numbers (BSNs) among ARQ blocks received through one frame within an ARQ receive (Rx) window, thereby generating one or more ARQ block groups; determining if the generated ARQ block groups are merged with the previously received one or more ARQ block groups in a group list in which previously received ARQ block groups are arranged according to BSNs; generating a purge timer whose time is set to a prescribed time in a first ARQ block of an ARQ block group having the largest BSN among the generated ARQ block groups if the generated ARQ block groups are not merged with the previously received one or more ARQ block groups; sliding a starting point of the Rx window up to an ARQ block following a last ARQ block of the generated ARQ block group if the purge timer reaches a timeout; and receiving new ARQ blocks within the slid Rx window.

### BRIEF DESCRIPTION OF THE DRAWINGS

The above and other exemplary features, aspects, and advantages of the present invention will be more apparent from the following detailed description taken in conjunction with the accompanying drawings, in which:

FIG. 1 is a diagram illustrating a protocol layer of a mobile internet standard 802.16;

FIGS. 2 and 3 are diagrams illustrating an operation of the prior purge timer;

FIG. 4 is a flowchart illustrating a process for extracting a Service Data Unit (SDU) from a Protocol Data Unit (PDU) delivered in a physical layer by a common ARQ block receiving apparatus;

FIG. 5 is a flowchart illustrating ARQ block processing according to an embodiment of the present invention;

FIG. 6 is a diagram illustrating an example of grouping ARQ blocks according to an embodiment of the present invention;

FIG. 7 is a diagram illustrating an example of forming an ARQ block group list through a data structure called Fragment Descriptor (FD) according to an embodiment of the present invention;

FIG. 8 is a diagram illustrating the result that, when a PDU illustrated in FIG. 6 is processed, a Fragment Descriptor (FD) is generated and ARQ blocks are grouped by using a group-link (gl) existing within the FD, and the result that the grouped ARQ blocks slide in a receive (Rx) window;

FIG. 9 is a diagram illustrating a FD linked list, as well as a group linked list regarding ARQ blocks previously received in FIG. 8 and currently received ARQ blocks;

FIG. 10 is a diagram illustrating an example in which two groups are formed by ARQ blocks which cannot slide an Rx window;

FIG. 11 is a diagram illustrating a first case where a single group is formed by ARQ blocks received by a Frame Number (FN) ‘1’ and a second case where two groups are formed by ARQ blocks received by the Frame Number (FN) ‘1’;

FIGS. 12A to 12C are diagrams illustrating purge timers generated in the second frame when the second frame arrives following the first frame;

FIGS. 13A and 13C are diagrams illustrating examples in each of which ARQ block groups received with retransmission from an ARQ transmitting apparatus meet an existing ARQ block group having continuous Block Sequence Numbers (BSNs) according to search results and then the retransmitted ARQ block groups are merged with the existing ARQ block group;

FIGS. 14A and 14B are diagrams illustrating respective cases where ARQ block groups are merged by a newly transmitted frame, and then purge timers are deleted;

FIGS. 15A to 15D are diagrams illustrating an example of enabling an Rx window to sequentially slide as purge timers generated in the first, second, and third frames respectively having FNs 1, 2, and 3 sequentially exceed the ARQ_RX_PURGE_TIMEOUT value; and

FIGS. 16A and 16B are a flowchart showing the operation of purge timers of an ARQ receiving apparatus according to an embodiment of the present invention.

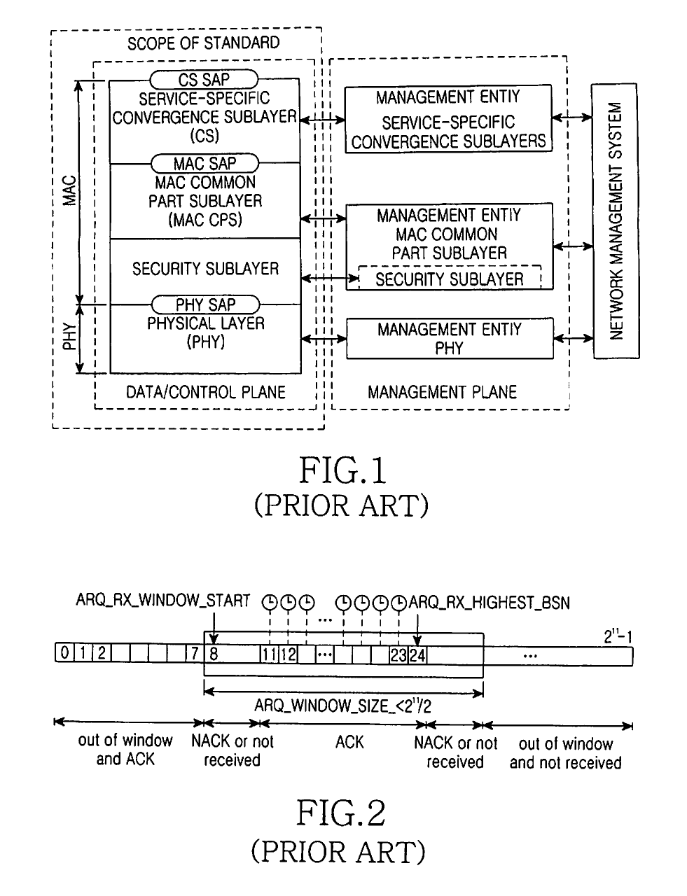

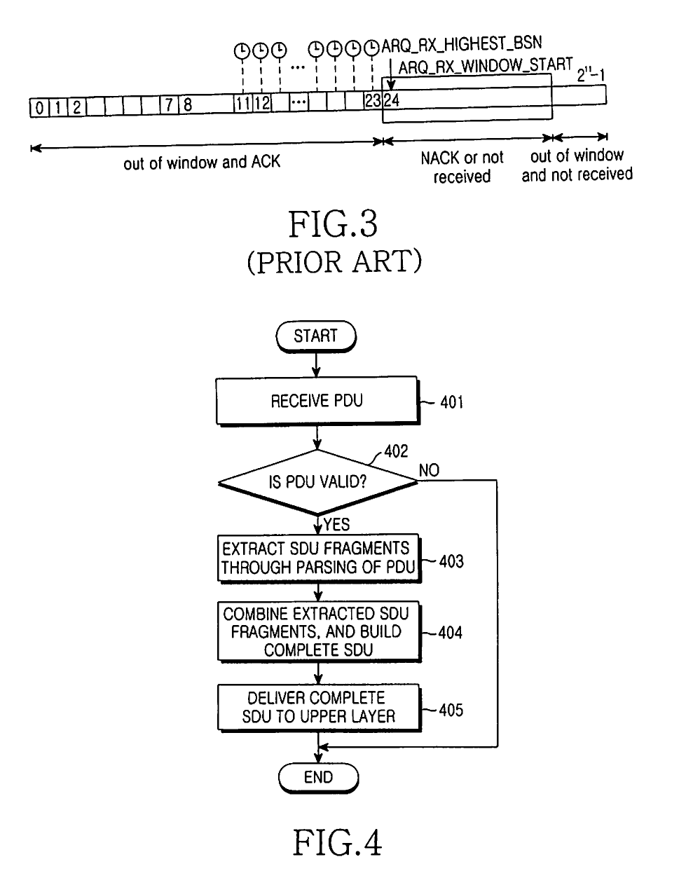

### DETAILED DESCRIPTION OF THE EXEMPLARY EMBODIMENTS

Hereinafter, exemplary embodiments of the present invention will be described in detail with reference to the accompanying drawings. In the following description of the present invention, a detailed description of known functions and configurations incorporated herein will be omitted when it may make the subject matter of the present invention rather unclear. In addition, the following terms correspond to terminology defined in consideration of the functions in the present invention, the terms can be different depending on users' and operators' intentions, precedents, and others. Hence, a definition of each term should be given based on the contents throughout the present specification.

In the present invention, a method is provided, in which Automatic Repeat reQuest (ARQ) blocks having continuous Block Sequence Numbers (BSNs) are grouped, thereby diminishing overhead caused when processing ARQ blocks, and reducing the generation of unnecessary ARQ block purge timers in a receive (Rx) window.

Above all, an operation of a common ARQ block receiving apparatus will be described.

FIG. 4 illustrates a process for extracting a Service Data Unit (SDU) from a Protocol Data Unit (PDU) delivered in a physical layer by the common ARQ block receiving apparatus.

With reference to FIG. 4, an ARQ block receiving apparatus of a Media Access Control (MAC) layer receives a PDU from a physical layer in step 401, and determines the validity of the received PDU in step 402. In step 403, based on the determination results, the ARQ block receiving apparatus parses a valid PDU. Through the above PDU parsing process, various header information is determined, and then a complete SDU or fragments of a SDU is/are extracted from a PDU based on the determined header information. In addition, the extracted SDU fragments are combined, and then a complete SDU is constructed. The process as described above is referred to as ‘SDU building.’ In step 405, complete SDUs generated in the above SDU building process are delivered to an upper layer.

An ARQ block processing operation according to embodiments of the present invention will be described in detail.

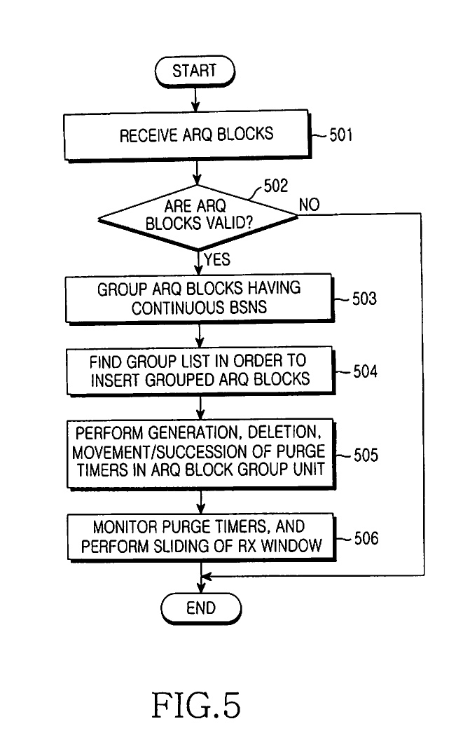

FIG. 5 illustrates an overall order of ARQ block processing by an ARQ block receiving apparatus according to an embodiment of the present invention.

Referring to FIG. 5, the ARQ block receiving apparatus receives ARQ blocks in step 501, and in step 502, determines the validity of the received ARQ blocks. The ARQ block receiving apparatus processes only ARQ blocks entering an receive (Rx) window. Accordingly, the ARQ block receiving apparatus expects a BSN of a received ARQ block to lie between ARQ_RX_WINDOW_START and the value of ‘ARQ_RX_WINDOW_START+ARQ_WINDOW_SIZE.’ If an ARQ block having an unexpected BSN value is received, or if an ARQ block whose BSN has a duplicate value as compared with a BSN of a previously received ARQ block is received, the ARQ block receiving apparatus determines that the relevant ARQ block is not valid, and thus does not process the relevant ARQ block, but discards it.

After determining the validity of the received ARQ block in this manner, the ARQ block receiving apparatus puts ARQ blocks having continuous BSNs together into one group in step 503. This has the purpose of applying, as a processing unit, an ARQ block group including the ARQ blocks having continuous BSNs, instead of applying each of the ARQ blocks as a processing unit.

According to the prior art, a scheme of managing ARQ blocks by assigning a data structure to each of the ARQ blocks has been adopted, and thus overhead caused by the processing of the ARQ blocks increases dramatically. In the mobile internet standards, ARQ BSNs ranging from ‘0’ to ‘2¹¹−1’ are assigned, and therefore, according to the prior management scheme as described above, 2¹¹ data structures must be managed. However, as in the present invention, if ARQ blocks are put together by the group and then processed in a group unit, data structures required to process the ARQ blocks can be greatly reduced.

In step 504, in order to determine a position into which the grouped ARQ blocks are inserted, a search is made for a group list. In step 505, according to search results, an operation for the generation, the deletion, and the movement or the succession of each purge timer with ARQ blocks as a group unit is performed. In step 506, as purge timers are monitored, the Rx window slides.

Next, a process for grouping the ARQ blocks will be described in detail.

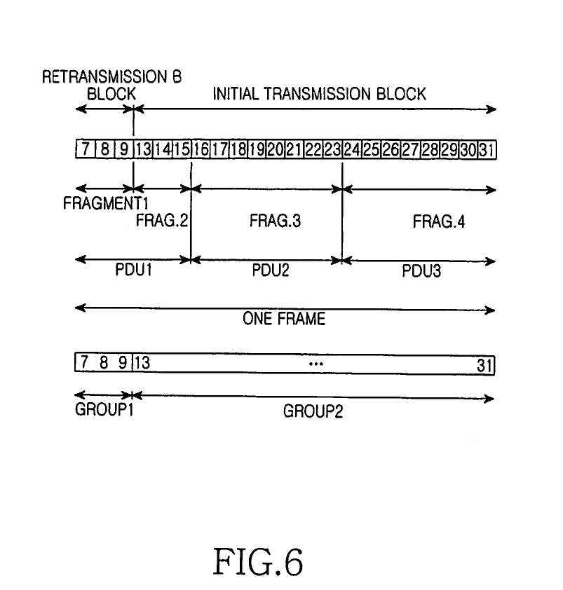

FIG. 6 illustrates the exemplification of grouping ARQ blocks according to an embodiment of the present invention.

With reference to FIG. 6, three PDUs (i.e., PDUs 1 to 3) are included in one frame, and a retransmission block and an initial transmission block are packed in a PDU 1.

In FIG. 6, ARQ blocks having BSNs #7 to #9 correspond to a retransmission block, and ARQ blocks having BSNs #13 to #31 correspond to an initial transmission block. If the BSNs of the ARQ blocks are continuous, the ARQ blocks having the continuous BSNs are put together into one group. In FIG. 6, since the BSNs of the ARQ blocks from #7 to #9 are continuous, one group (i.e., a group 1) is formed by these ARQ blocks, and since the BSNs of the ARQ blocks from #13 to #31 are continuous, the other group (i.e., a group 2) is formed by those ARQ blocks.

The ARQ block receiving apparatus has a data structure in which a processing unit can be managed. Also, so as to combine a complete SUD from several ARQ blocks in the ARQ block receiving apparatus, a question operation (i.e., search) and a change operation (i.e., insert, delete, etc.) on ARQ block groups are necessary. A linked list corresponds to a data structure in which the objects are arranged according to a linear order. The ARQ block receiving apparatus carries out a question operation and a change operation on a typically required data structure by using the linked list.

By using a double linked list, an operation of an ARQ block receiving apparatus according to an embodiment of the present invention will be described. However, the present invention is not limited to using a particular linked list.

In the prior ARQ block receiving apparatus, regarding ARQ blocks as a basic processing unit, a data structure is assigned to each ARQ block, and then these data structures are managed. This prior art scheme raises such problems such as the occurrence of a serious overhead as described above. Accordingly, in the present invention, a data structure for a fragment corresponding to an SDU transmission unit is implemented, and then a data structure capable of grouping ARQ blocks is added within the data structure. For the sake of convenience, a data structure for SDU fragment processing is named a “Fragment Descriptor (FD).” In addition, a data structure necessary to form each group of ARQ blocks having continuous BSNs is named a “group-link (gl).” Each gl is placed within a FD data structure.

ARQ blocks existing within an FD always have their respective BSNs which are continuous. Multiple ARQ blocks can be included in a single SDU fragment. Actually, each ARQ block group is in a state where multiple FDs are connected. In an embodiment of the present invention, a group of ARQ blocks (hereinafter “ARQ block group”), in which the ARQ blocks having continuous BSNs are connected, is specified as a process unit.

The following Table 1 expresses a part of a specific field of an FD data structure according to an embodiment of the present invention.

TABLE 1

| typedef struct FragmentDescriptor _s | |
|---|---|
| { | |
| FragmentDescriptor_t *next; | |
| FragmentDescriptor_t *prev; | |
| union { | |
| FragmentDescriptor_t *last; | |
| FragmentDescriptor_t *first; | |
| } gl; | |
| unsigned char | *pData; |
| unsigned int | DataSize; |
| unsigned int | starBSN; |
| unsigned int | lastBSN; |
| unsigned int | FN; |
| timer_type | purge_timer; |
| ... | |

} FragmentDescriptor_t;

As in Table 1, within an FD, previous and next points for a double linked list exist, and placing a gl within the FD enables grouping of ARQ blocks. In a single group, one or more FDs are connected by a gl. A first field of the gl is enabled to indicate a first FD of the group, and a last field of the gl is enabled to indicate a last FD of the group. Through the FD data structure as described above, the double linked list and a group list can be implemented, and thus profit can be derived by carrying out an operation on an ARQ block group.

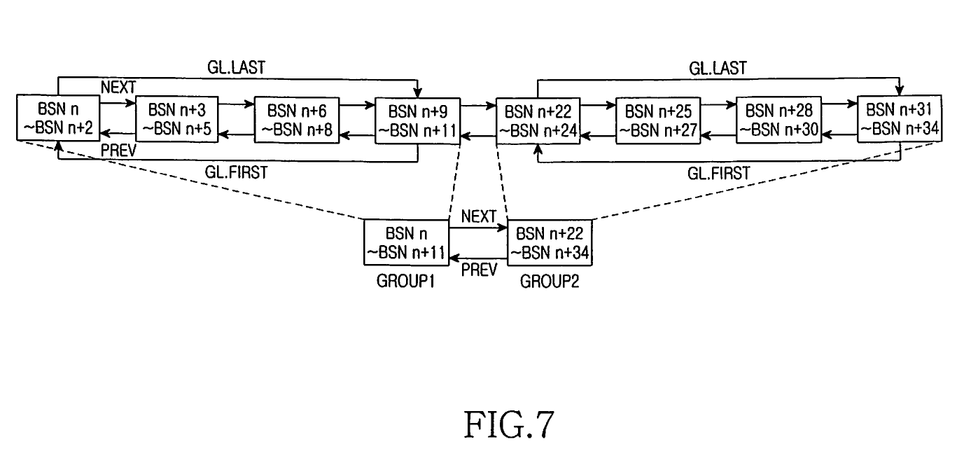

FIG. 7 depicts an example of forming an ARQ block group list through the FD data structure expressed in Table 1.

With reference to FIG. 7, a group 1 is formed by ARQ blocks having their respective BSNs due to the continuous BSNs ‘n’ to ‘n+11’, and a group 2 is formed by ARQ blocks having their respective BSNs due to the continuous BSNs ‘n+22’ to ‘n+34.’ Since a BSN ‘n+11’ and a BSN ‘n+22’ are discontinuous, a single group cannot be formed.

When some of ARQ blocks that make up a SDU are lost on a transmission channel, a receiving apparatus does not contribute to constructing a complete SDU, and accordingly, the lost ARQ blocks come to remain in a block list. Thereafter, if the receiving apparatus waits for receiving retransmitted ARQ blocks following the retransmission of the ARQ blocks required to construct a SDU, and then receives the retransmitted ARQ blocks (or retransmission ARQ blocks), the receiving apparatus finds an FD list, and then detects a position where the received retransmission ARQ blocks are needed. The receiving apparatus finds the FD list with each of the BSNs of the ARQ blocks as a key value. Next, an operation, such as search, insert, etc., is performed by the FD. However, in a period that FDs having continuous BSNs are connected, the retransmission ARQ blocks are not needed. It is therefore an unnecessary task to find FDs existing in a period that BSNs are continuous. To examine a case illustrated in FIG. 7, it is unnecessary to find FDs existing between a BSN ‘n’ and a BSN ‘n+11’, and it is also unnecessary to find FDs existing between a BSN ‘n+11’ and a BSN ‘n+22.’ Accordingly, if ARQ blocks having continuous BSNs are put together into one group and then the group is specified as a comparative unit, the above unnecessary operation can be omitted.

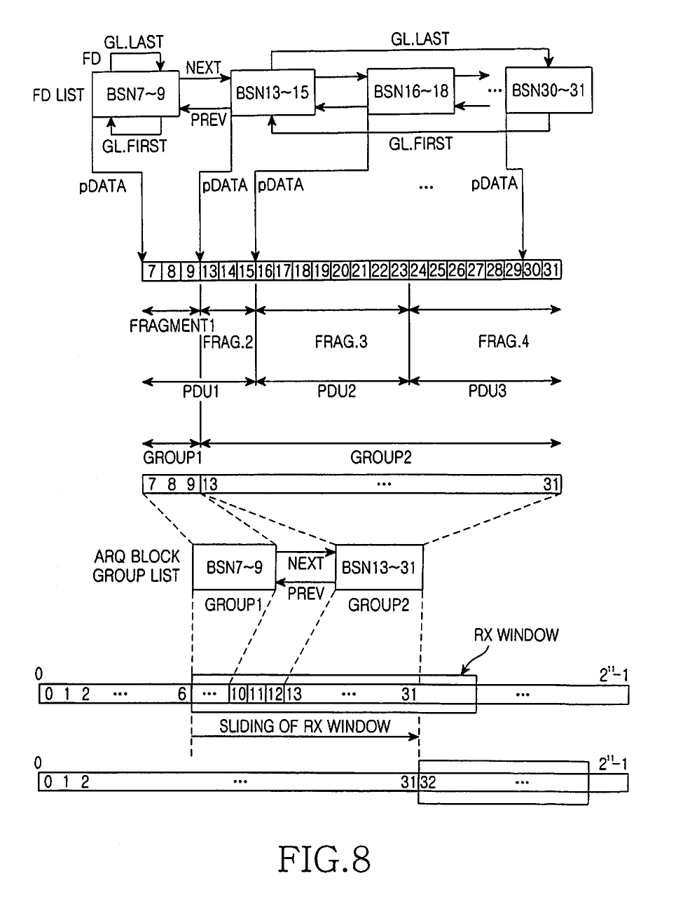

FIG. 8 illustrates the result that, when a PDU illustrated in FIG. 6 is processed, a FD is generated and ARQ blocks are grouped in a gl existing within the FD, and the result that the grouped ARQ blocks slide in an Rx window.

In FIG. 6, ARQ blocks corresponding to BSNs ‘7’ to ‘9’ have continuous BSNs, and thus form one group (i.e., a group 1). In addition, ARQ blocks corresponding to BSNs ‘13’ to ‘31’ have continuous BSNs, and thus form the other group (i.e., a group 2). Also, in TABLE 1, it can be determined that a list regarding ARQ block groups is formed through a gl data structure within an FD list. If one ARQ block group includes more ARQ blocks, and if more ARQ block groups exist, profit derived from an operation by the ARQ block becomes larger.

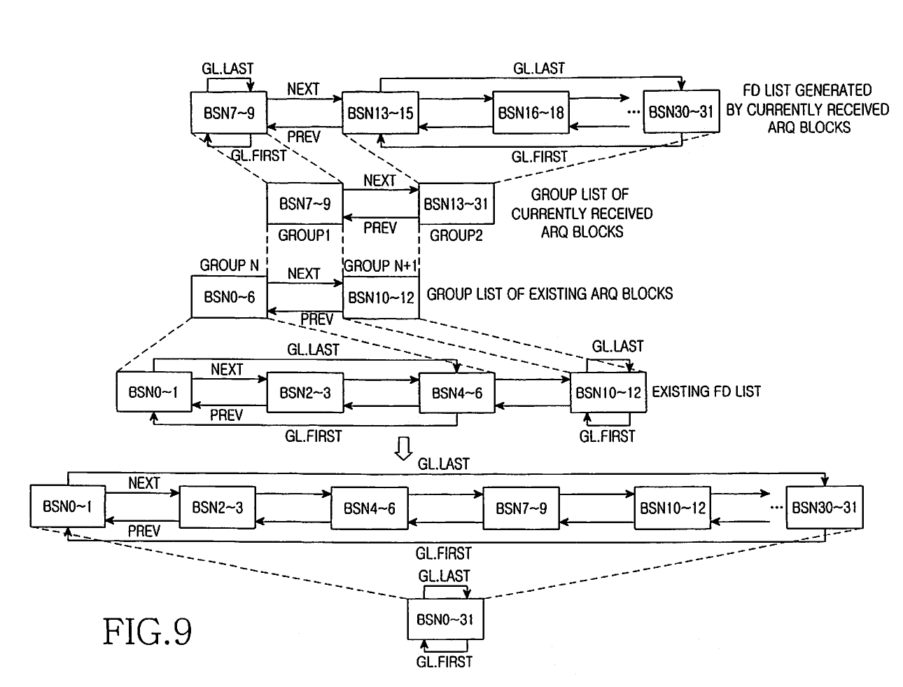

FIG. 9 illustrates an FD linked list, as well as a group linked list regarding ARQ blocks previously received in FIG. 8 and currently received ARQ blocks.

To examine a part below an arrow in FIG. 9, it can be determined that the BSNs (i.e., BSNs ‘0’ to ‘6’ and BSNs ‘10’ to ‘12’) of currently received ARQ block groups (i.e., a GROUP 1 and a GROUP 2) and the BSNs (i.e., BSNs ‘7’ to ‘9’ and BSNs ‘13’ to ‘31’) of previously received ARQ block groups (i.e., a GROUP ‘N’ and a GROUP ‘N+1’) are continuous, and are thus merged into another group.

Next, a description will be made of a method for operating a purge timer according to an embodiment of the present invention.

As described above, it is inefficient to operate a purge timer by the ARQ block, and therefore a purge timer is operated by the frame in an embodiment of the present invention. To this end, Frame Numbers (FNs) are set within an FD, and by determining, with a comparison between FNs, an ARQ block group in relation to a frame through which the ARQ block group is received, the generation, the deletion, and the succession/movement of each purge timer are determined.

An FN increases by ‘1’ every time a frame is received. When BSNs of ARQ blocks configuring a first ARQ block group and BSNs of ARQ blocks configuring of a second ARQ block group adjacent to the first ARQ block group are continuous, relevant ARQ block groups are merged into a single ARQ block group. In this manner, one ARQ block group can be generated by merging a first ARQ block group with a second ARQ block group. FDs having the values of FNs different from one another can coexist within one ARQ block group.

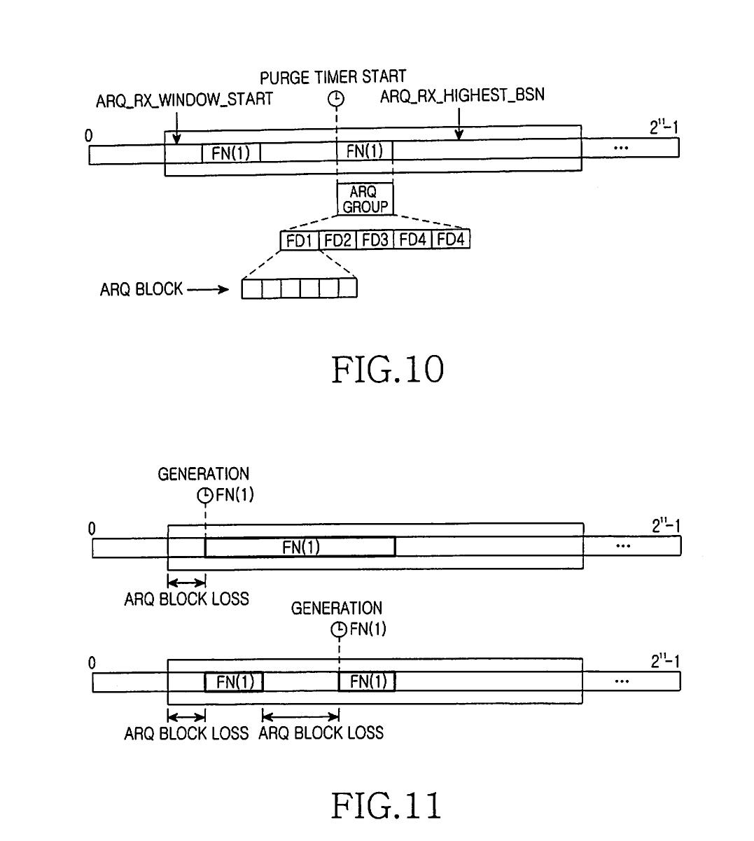

FIG. 10 is a diagram illustrating an example in which two ARQ block groups all having an FN ‘1’ are formed by ARQ blocks which cannot slide an Rx window.

Multiple ARQ blocks exist within one FD, and multiple FDs exist in one ARQ block group. A purge timer is placed within an FD. One ARQ block group might include an FD equipped with a purge timer. In FIG. 10, a purge timer operates within the first FD (i.e., an FD 1) included in the second ARQ group.

As described above in a description regarding FIG. 8, the ARQ block receiving apparatus operates a cue for FDs. The FD cue connects FD elements to a doubled linked list. In FIG. 8, the example of grouping ARQ blocks by using a form of the FD cue and a gl data structure has already been described. Based on the above FD cues used in grouping ARQ blocks, a description will be made of a method for operating a purge timer according to an embodiment of the present invention.

First, ARQ blocks having continuous BSNs among ARQ blocks received through the same frame are grouped within the Rx window. In addition, if an ARQ block which cannot slide the Rx window is received, a purge timer is generated in the relevant ARQ block.

Second, in a case where an ARQ block group does not exist within the Rx window and an ARQ block group received through the same frame cannot slide the Rx window, if one relevant ARQ block group is generated, a purge timer is generated within a first FD configuring the relevant ARQ block group. Also, if two or more relevant ARQ block groups are generated, a purge timer is generated within a first FD in the last ARQ block group.

FIG. 11 illustrates a first case where a single group is formed by ARQ blocks received by a Frame Number (FN) ‘1’, and a second case where two groups are formed by ARQ blocks received by the Frame Number (FN) ‘1’.

With reference to FIG. 11, it can be confirmed that if the two ARQ block groups are formed, a purge timer (refer to FN (1)) is generated within a first FD of the second group among the ARQ block groups.

Third, even if one or multiple FDs having their respective operating purge timers exist within the Rx window, the order that the FN value increases must be maintained. Accordingly, ARQ blocks which cannot slide the Rx window can have a purge timer, but a purge timer is not generated in ARQ blocks which do not follow the order that the FN value increases.

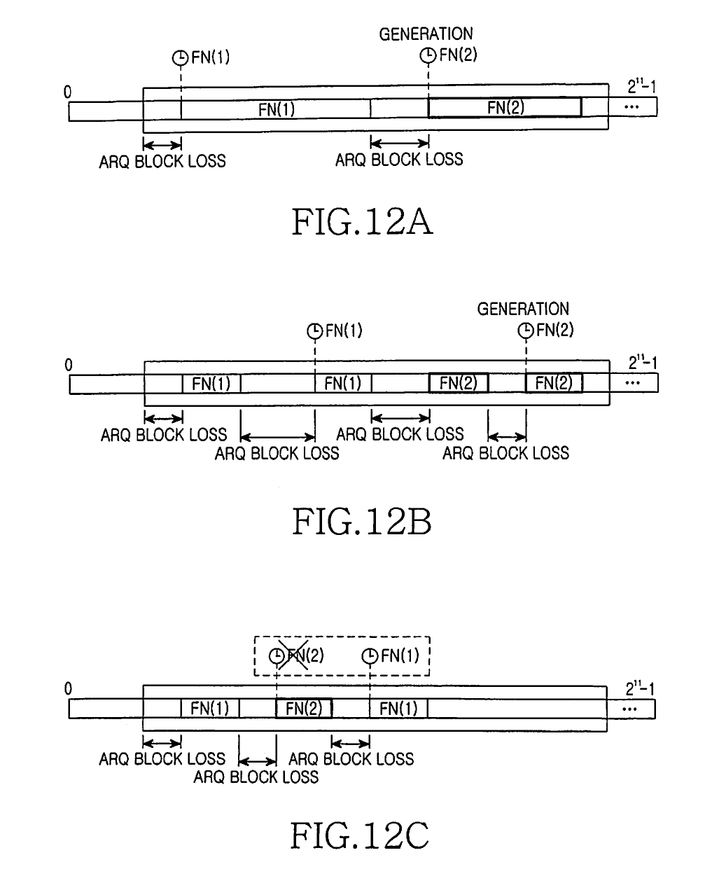

FIGS. 12A to 12C illustrate purge timers generated in the second frame when the second frame arrives following the first frame.

FIGS. 12A to 12C all satisfy the above-described second principle. In FIG. 12C, a group formed by the second frame does not follow the increasing order of FNs, and thus a purge timer is not generated in the group.

Fourth, multiple adjacent ARQ block groups having continuous BSNs are merged into a new ARQ block group. At this time, if one group has a purge timer among the groups participating in the mergence, a relevant purge timer is moved to a first FD of a new group to be generated following the mergence, and is then successively used for the first FD of the new group.

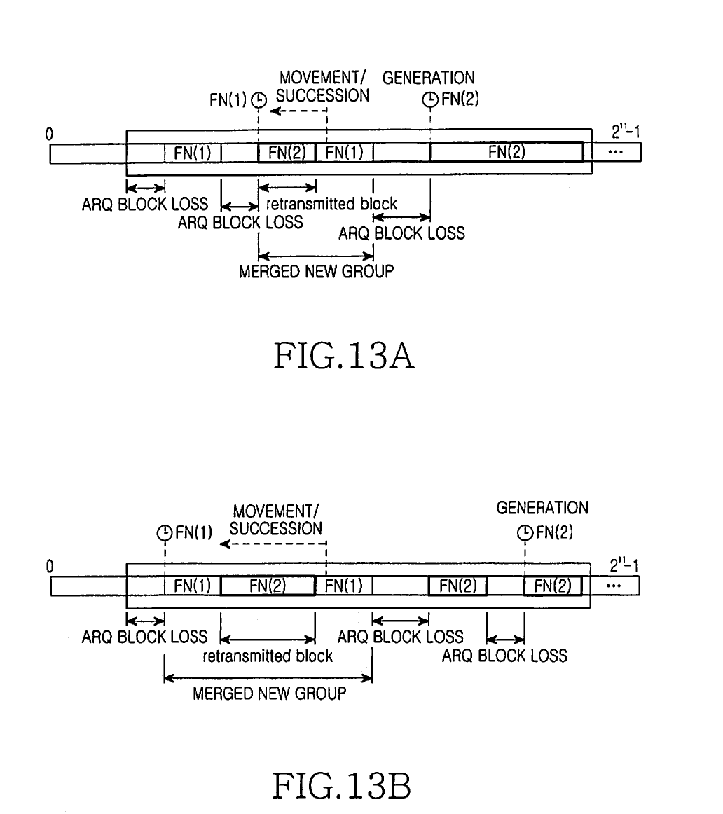

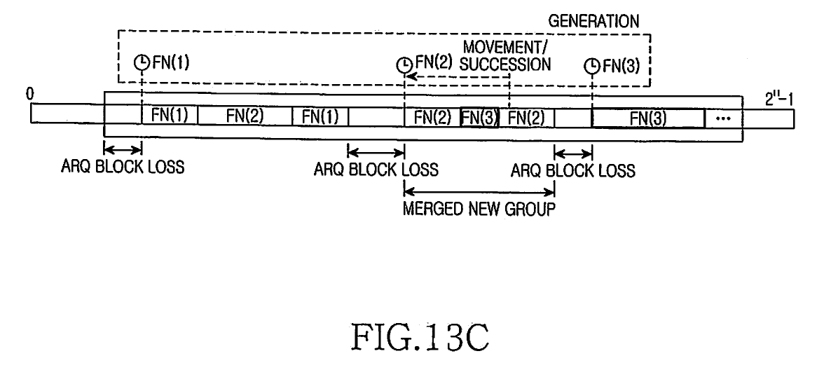

FIGS. 13A and 13C illustrate examples in each of which ARQ block groups received with retransmission from an ARQ transmitting apparatus meet an existing ARQ block group having continuous BSNs according to search results, and then the retransmitted ARQ block groups are merged with the existing ARQ block group.

In FIGS. 13A and 13B, an ARQ block group formed by the second frame having an FN ‘2’ is merged with an ARQ block group formed by the first frame having an FN ‘1’, and as a result, a purge timer generated while receiving the first frame having the FN ‘1’ is moved to the second frame having the FN ‘2’, and is then successively used for the second frame having the FN ‘2’. In FIG. 13B, since a BSN of a first ARQ block group of the first frame having the FN ‘1’ and a BSN of a first ARQ block group of the second frame having the FN ‘2’ are continuous, a purge timer generated in a last ARQ block group of the first frame having the FN ‘1’ is moved to a first ARQ block group of the first frame having the FN ‘1’, and is then successively used for the first ARQ block group of the first frame. In FIG. 13C, an ARQ block group formed by the third frame having an FN ‘3’ is merged with an ARQ block group formed by the second frame having an FN ‘2’ with the second and third frames as the front and the rear, and as a result, a purge timer generated while receiving the second frame having the FN ‘2’ is moved to the second frame having the FN ‘2’, which is merged to the forward direction of the third frame having the FN ‘3’, and is then successively used for the second frame having the FN ‘2’. FIGS. 13A to 13C all hold the increasing order of FNs.

Fifth, if one or more ARQ block groups have their respective purge timers among merged ARQ block groups, a purge timer generated within an FD having the smallest FN value among the groups having their respective purge timers is maintained within a first FD of a new ARQ block group to be generated following the mergence. Only a first generated purge timer and a last generated purge timer are maintained, and the remaining purge timers are deleted.

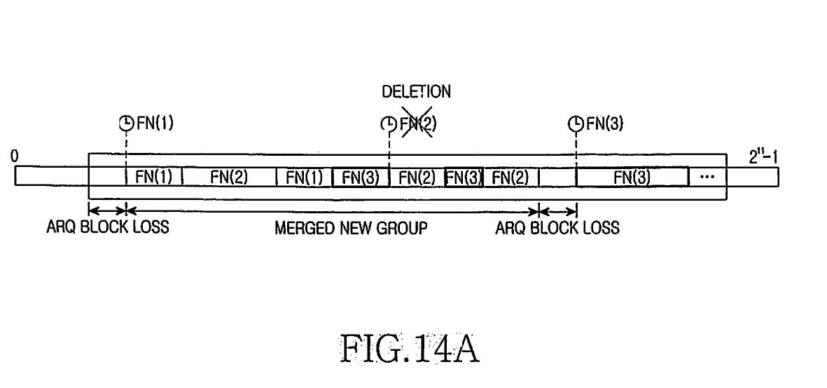

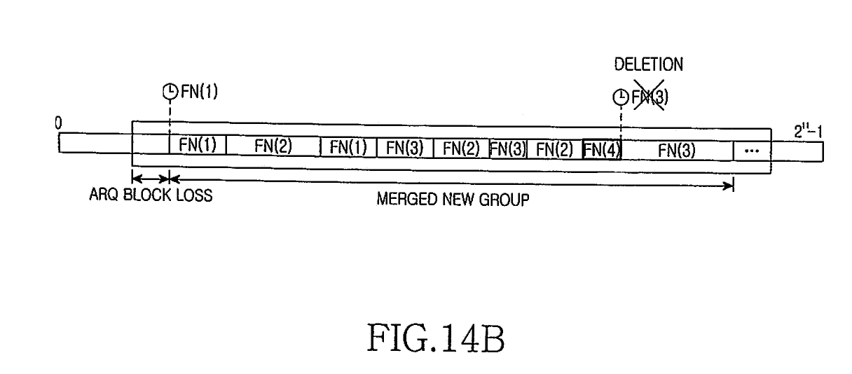

FIG. 14A illustrates a case where an ARQ block group including a purge timer generated in a first frame having an FN ‘1’ and an ARQ block group including a purge timer generated in a second frame having an FN ‘2’ are merged by an ARQ block group generated in a third frame having an FN ‘3’ into one group. As described above, it can be confirmed that a purge timer generated in the first frame having the FN ‘1’ is maintained within a first FD of an ARQ block group to be newly generated according to mergence results, and then the remaining purge timer generated in the second frame having the FN ‘2’ is deleted.

FIG. 14B illustrates a case where a purge timer generated in a third frame having an FN ‘3’ according to the results of mergence by an ARQ block group generated in a fourth frame having an FN ‘4’ is deleted.

Sixth, purge timers are maintained according to the increasing order of FNs, and thus, that each purge timer exceeds the ARQ_RX_PURGE_TIMEOUT value, is also fulfilled according to the increasing order of FNs.

If a purge timer exceeds the ARQ_RX_PURGE_TIMEOUT value, the Rx window slides in such a manner that an ARQ_RX_WINDOW_START may indicate a BSN following the last BSN of an ARQ block group including a relevant purge timer. ARQ blocks whose BSNs are less than the ARQ_RX_WINDOW_START value acquired by sliding of the Rx window contribute to constructing an SDU, and ARQ blocks that do not contribute to constructing the SDU are deleted.

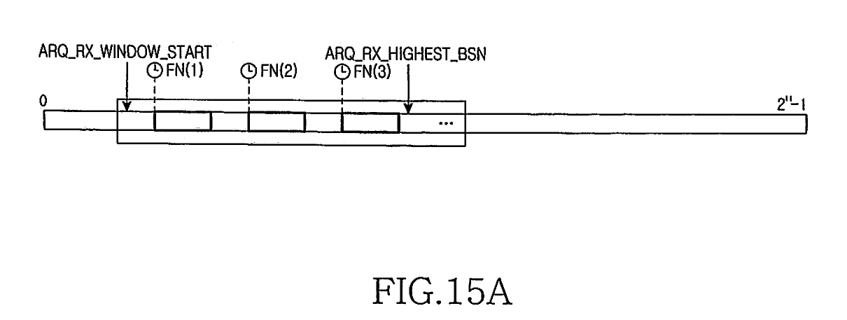

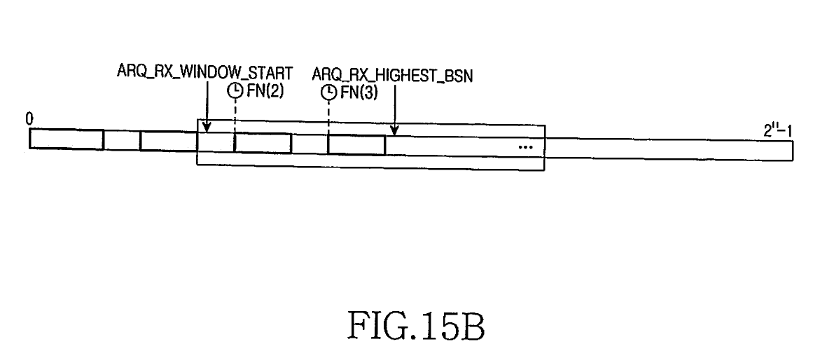

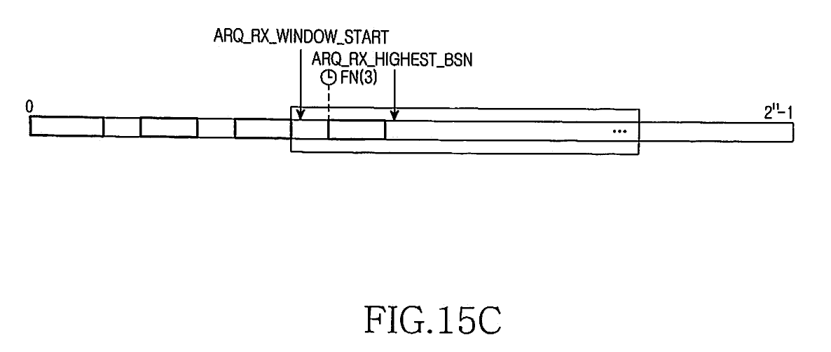

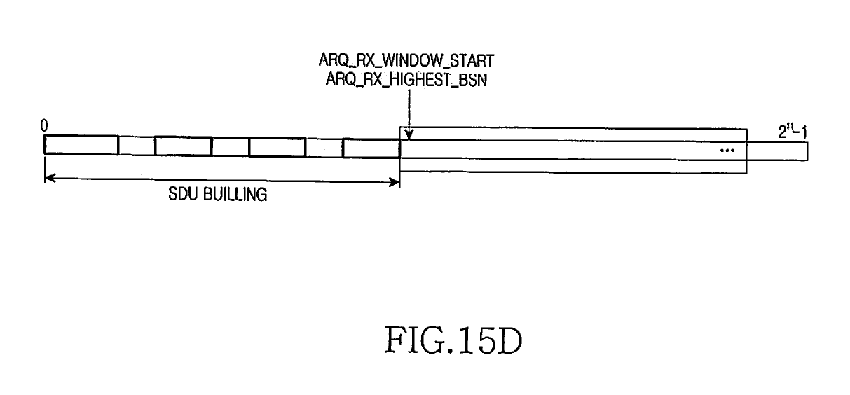

FIGS. 15A to 15D illustrate the exemplification of enabling an Rx window to sequentially slide as purge timers generated in the first, second, and third frames, respectively having FNs 1, 2, and 3, sequentially exceed the ARQ_RX_PURGE_TIMEOUT value. As the Rx window slides, ARQ blocks out of the Rx window contribute to the generation of an SDU. The generated SDU is transferred to an upper layer, and ARQ blocks which are placed out of the Rx window but cannot contribute to the generation of the SDU are removed.

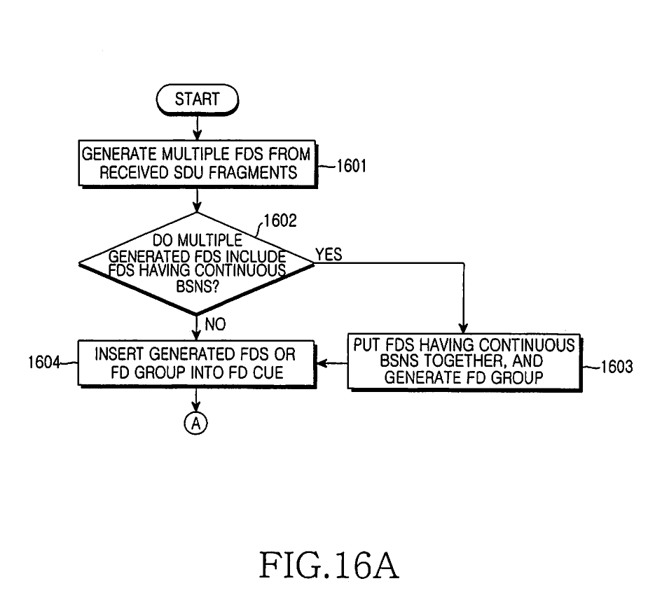

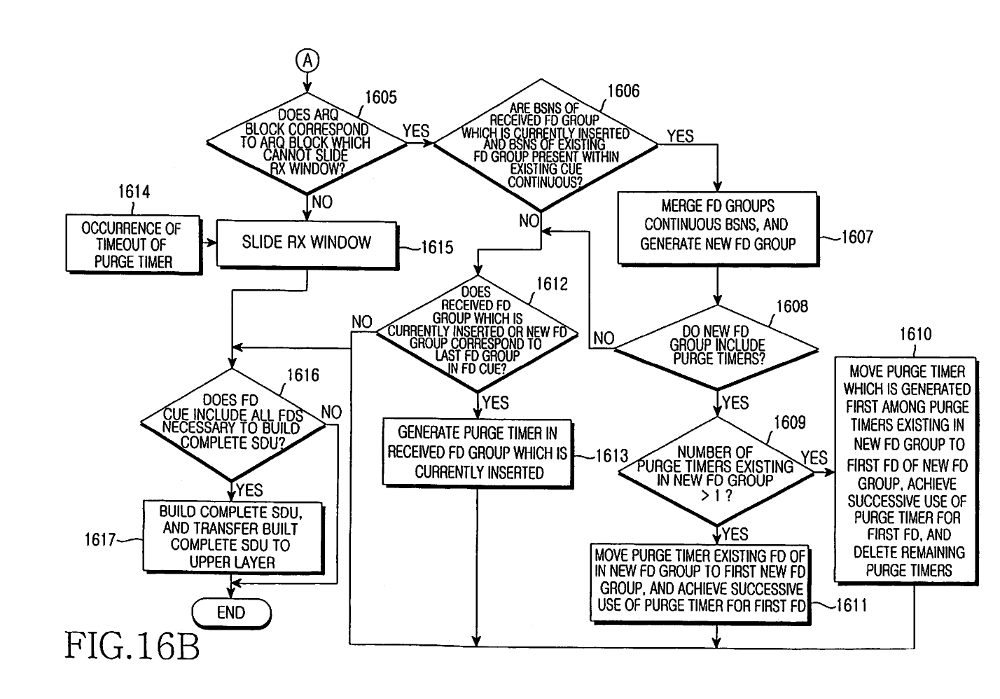

FIGS. 16A and 16B are a flowchart showing the operation of purge timers of the ARQ receiving apparatus according to an embodiment of the present invention.

Referring to FIGS. 16A and 16B, in step 1601, the ARQ transmitting apparatus generates multiple FDs from the received SDU fragments (i.e., ARQ blocks), and in step 1602, determines if FDs having continuous BSNs exist among the multiple generated FDs. If it is determined in step 1602 that FDs having continuous BSNs exist, the ARQ transmitting apparatus puts the FDs together into ARQ block groups in step 1603, and in step 1604, inserts an ARQ block group into an FD cue. If it is determined in step 1602 that FDs having continuous BSNs do not exist, the ARQ transmitting apparatus proceeds to step 1604, and then inserts the generated FD into an FD cue as it is.

In step 1605, it is determined if the FD or the ARQ block group inserted into the FD cue can slide the Rx window. If it is determined in step 1605 that the FD or the ARQ block group inserted into the FD cue can slide the Rx window, the Rx window is slid in step 1615, and in step 1616, the procedure determines if conditions where an SDU is to be generated are satisfied. If it is determined in step 1616 that the conditions where an SDU is to be generated are satisfied, in step 1617, the SDU is generated, and then the generated SDU is transferred to an upper layer. Also, in a case where a timeout of a purge timer occurs in step 1614, the procedure proceeds to step 1615.

If it is determined in step 1605 that the FD or the ARQ block group cannot slide the Rx window, the procedure determines in step 1606 if BSNs of a recently inserted ARQ block group and BSNs of an existing ARQ block group which is present within an FD cue are continuous. In step 1607, ARQ block groups whose BSNs are continuous are merged into a new ARQ block group. In step 1608, the procedure determines if purge timers exist in the new ARQ block group, and if the purge timers exist, the procedure determines the number of the purge timers in step 1609. If the number of the purge timers equals two or more, in step 1610, a purge timer which is generated first is moved to a first ARQ block of the new ARQ block group, the purge timer is then successively used for the first ARQ block of the new ARQ block group, and then the remaining timers are deleted. If the number of the purge timers equals one, in step 1611, a relevant purge timer is moved to a first ARQ block of the new ARQ block group, and is then successively used for the first ARQ block. The procedure proceeds to step 1616 where a procedure for generating an SDU is performed.

Also, if it is determined in step 1606 that BSNs of the recently inserted ARQ block group and BSNs of the existing ARQ block group which is present within the FD cue are not continuous, or if purge timers do not exist, the procedure determines in step 1612 if the recently inserted ARQ block group or the new block group corresponds to an ARQ block group in regard to the most recently transmitted frame. If it is determined in step 1612 that the recently inserted ARQ block group or the new block group corresponds to an ARQ block group in regard to the most recently transmitted frame, a purge timer is generated in a first ARQ block of a relevant ARQ block group in step 1613. Then, the procedure proceeds to step 1616 where a procedure for generating an SDU is performed.

In the present invention configured to operate as described in detail above, effects acquired by a representative one of disclosed inventions are simply described as follows.

According to the present invention, in a Mobile Internet receiving apparatus, ARQ blocks are grouped, thereby greatly reducing the amount of operations required in a case where the respective ARQ blocks are processed separately, and greatly reducing overhead occurring in the same case.

Also, the generation of unnecessary purge timers in an Rx window of the mobile internet receiving apparatus is reduced, and accordingly, the operation of purge timers can be efficiently performed.

While the invention has been shown and described with reference to certain exemplary embodiments thereof, it will be understood by those skilled in the art that various changes in form and details may be made therein without departing from the spirit and scope of the invention. Therefore, the spirit and scope of the present invention must be defined not by described embodiments thereof but by the appended claims and equivalents of the appended claims.

What is claimed is:

1. A method for processing an Automatic Repeat reQuest (ARQ) block by a receiving apparatus of a Wireless Broadband (WiBro) system, comprising the steps of:
grouping ARQ blocks having continuous Block Sequence Numbers (BSNs) among ARQ blocks received through one frame within an ARQ receive (Rx) window, thereby generating one or more ARQ block groups;
determining if the generated ARQ block groups are merged with the previously received one or more ARQ block groups in a group list in which previously received ARQ block groups are arranged according to BSNs;
generating a purge timer in a first ARQ block of an ARQ block group having the largest BSN among the generated ARQ block groups if the generated ARQ block groups are not merged with the previously received one or more ARQ block groups; and
sliding a starting point of the Rx window up to an ARQ block following a last ARQ block of the generated ARQ block group if the purge timer reaches a timeout, and then receiving new ARQ blocks within the slid Rx window.

2. The method as claimed in claim 1, wherein, in the step of generating a purge timer, if an ARQ block group having a previously generated purge timer exists among previously received ARQ block groups having BSNs greater than a BSN of an ARQ block group in which the purge timer is to be generated within the Rx window, the purge timer is not generated in the ARQ block group in which the purge timer is to be generated, and the previously generated purge timer is maintained.

3. The method as claimed in claim 1, wherein, in the step of generating a purge timer, if the ARQ block groups are merged and a new ARQ block group is generated, the previously generated purge timer existing in the new ARQ block group is moved to a first ARQ block of the generated new ARQ block group, and is successively used for the first ARQ block of the new ARQ block group.

4. The method as claimed in claim 3, wherein, in the step of generating a purge timer, if the generated new ARQ block group includes two or more previously generated purge timers, only one purge timer placed in an ARQ block having the smallest BSN is maintained, and other purge timers are deleted.

5. The method as claimed in claim 1, further comprising generating a Service Data Unit (SDU) from the ARQ block groups out of the Rx window, and transferring the generated SDU to an upper layer.

6. A method for processing an Automatic Repeat reQuest (ARQ) block by a receiving apparatus of a Wireless Broadband (WiBro) system, comprising the steps of:
grouping ARQ blocks having continuous Block Sequence Numbers (BSNs) among ARQ blocks received through one frame within an ARQ receive (Rx) window, thereby generating one or more ARQ block groups;
adding the generated ARQ block groups to a group list in which previously received ARQ block groups are arranged according to BSNs, and merging the generated ARQ block groups with the previously received one or more ARQ block groups, thereby rearranging the group list;
generating a Service Data Unit (SDU) from the ARQ block groups with reference to the rearranged group list; and
transferring the generated SDU to an upper layer.

7. The method as claimed in claim 6, wherein the step of rearranging the group list comprises:
generating a purge timer in a first ARQ block of an ARQ block group having the largest BSN among the generated ARQ block groups if the generated ARQ block groups are not merged with the previously received one or more ARQ block groups in the group list on which previously received ARQ block groups are arranged in the order of the BSNs; and
sliding a starting point of the Rx window up to an ARQ block following a last ARQ block of the generated ARQ block group if the purge timer reaches a timeout.

8. The method as claimed in claim 7, wherein, in the step of generating a purge timer, if an ARQ block group having a previously generated purge timer exists among previously received ARQ block groups all having BSNs greater than a BSN of an ARQ block group in which the purge timer is to be generated within the Rx window, the purge timer is not generated in the ARQ block group in which the purge timer is to be generated, and the previously generated purge timer is maintained.

9. The method as claimed in claim 7, wherein, in the step of generating a purge timer, if the ARQ block groups are merged and a new ARQ block group is generated, the previously generated purge timer existing in the new ARQ block group is moved to a first ARQ block of the generated new ARQ block group and is successively used for the first ARQ block of the new ARQ block group.

10. The method as claimed in claim 9, wherein, in the step of generating a purge timer, if the generated new ARQ block group includes two or more previously generated purge timers, only one purge timer placed in an ARQ block having the smallest BSN is maintained, and other purge timers are deleted.

11. A receiving apparatus for processing an Automatic Repeat reQuest (ARQ) block in a Wireless Broadband (WiBro) system, comprising:
a physical entity for receiving data including multiple ARQ blocks from a transmitting apparatus; and
a Media Access Control (MAC) entity for grouping ARQ blocks having continuous Block Sequence Numbers (BSNs) among the ARQ blocks received through one frame within an ARQ receive (Rx) window from the physical entity and generating one or more ARQ block groups, for determining if the generated ARQ block groups are merged with the previously received one or more ARQ block groups in a group list on which previously received ARQ block groups are arranged according to BSNs, for generating a purge timer in a first ARQ block of an ARQ block group having the largest BSN among the generated ARQ block groups if the generated ARQ block groups are not merged with the previously received one or more ARQ block groups, and for sliding a starting point of the Rx window up to an ARQ block following a last ARQ block of the generated ARQ block group if the purge timer reaches a timeout and then receiving new ARQ blocks from the physical entity within the slid Rx window.

12. The receiving apparatus as claimed in claim 11, wherein, if an ARQ block group having a previously generated purge timer exists among previously received ARQ block groups all having BSNs greater than a BSN of an ARQ block group in which the purge timer is to be generated within the Rx window, the MAC entity does not generate the purge timer in the ARQ block group in which the purge timer is to be generated, and the previously generated purge timer is maintained.

13. The receiving apparatus as claimed in claim 11, wherein, if the ARQ block groups are merged and then a new ARQ block group is generated, the MAC entity moves the previously generated purge timer existing in the new ARQ block group to a first ARQ block of the generated new ARQ block group, and the previously generated purge timer is successively used for the first ARQ block of the new ARQ block group.

14. The receiving apparatus as claimed in claim 13, wherein, if the generated new ARQ block group includes two or more previously generated purge timers, the MAC entity maintains only one purge timer placed in an ARQ block having the smallest BSN, and other purge timers are deleted.

15. The receiving apparatus as claimed in claim 11, wherein the MAC entity generates a Service Data Unit (SDU) from the ARQ block groups out of the Rx window, and transfers the generated SDU to an upper layer.

16. A receiving apparatus for processing an Automatic Repeat reQuest (ARQ) block in a Wireless Broadband (WiBro) system, comprising:
a physical entity for receiving data including multiple ARQ blocks from a transmitting apparatus; and
a Media Access Control (MAC) entity for grouping ARQ blocks having continuous Block Sequence Numbers (BSNs) among the ARQ blocks received through one frame within an ARQ receive (Rx) window from the physical entity and generating one or more ARQ block groups, for adding the generated ARQ block groups to a group list on which previously received ARQ block groups are arranged according to BSNs, merging the generated ARQ block groups with the previously received one or more ARQ block groups and then rearranging the group list, and for generating a Service Data Unit (SDU) from the ARQ block groups with reference to the rearranged group list and then transferring the generated SDU to an upper layer.

17. The receiving apparatus as claimed in claim 16, wherein the MAC entity generates a purge timer in a first ARQ block of an ARQ block group having the largest BSN among the generated ARQ block groups if the generated ARQ block groups are not merged with the previously received one or more ARQ block groups in the group list on which previously received ARQ block groups are arranged in the order of the BSNs, and slides a starting point of the Rx window up to an ARQ block following a last ARQ block of the generated ARQ block group if the purge timer reaches a timeout.

18. The receiving apparatus as claimed in claim 17, wherein, if an ARQ block group having a previously generated purge timer exists among previously received ARQ block groups all having BSNs greater than a BSN of an ARQ block group in which the purge timer is to be generated within the Rx window, the MAC entity does not generate the purge timer in the ARQ block group in which the purge timer is to be generated, but maintains the previously generated purge timer.

19. The receiving apparatus as claimed in claim 17, wherein, if the ARQ block groups are merged and then a new ARQ block group is generated, the MAC entity moves the previously generated purge timer existing in the new ARQ block group to a first ARQ block of the generated new ARQ block group, and the previously generated purge timer is successively used for the first ARQ block of the new ARQ block group.

20. The receiving apparatus as claimed in claim 19, wherein, if the generated new ARQ block group includes two or more previously generated purge timers, the MAC entity maintains only one purge timer placed in an ARQ block having the smallest BSN, and deletes other purge timers.
